(19) United States
(12) Patent Application Publication
(10) Pub. No.: US 2004/0267648 A1
(43) Pub. Date: Dec. 30, 2004

(54) Data totaling using interval-based subtotals

(75) Inventor: Rene C. Schaub, Stanford, CA (US)

Correspondence Address: Shemwell Gregory & Courtney LLP, Suite 201, 4880 Stevens Creek Boulevard, San Jose, CA, 95129-1034, US

(73) Assignee: Oracle International Corporation, Redwood Shores, CA (US)

(21) Appl. No.: 10/641,385

(22) Filed: Aug. 13, 2003

Related U.S. Application Data
(60) Provisional application No. 60/483,541, filed on Jun. 26, 2003.

(51) Int. Cl. G06F 17/60

(52) U.S. Cl. 705/35

(57) ABSTRACT

A method and apparatus for generating a grand total. First totaled values that correspond to respective first intervals within a range of intervals are generated. Second totaled values that correspond to respective second intervals within the range of intervals are also generated, each of the second totaled values including at least one of the first totaled values and each of the second intervals encompassing at least one of the first intervals. A value that indicates a sub-range within the range of intervals is obtained, and a grand total is generated by totaling the second totaled values for which the corresponding second intervals are encompassed by the sub-range and the first totaled values for which the corresponding first intervals are encompassed by the sub-range, excluding the first totaled values that are included in the second totaled values for which the corresponding second intervals are encompassed by the sub-range.

### CROSS-REFERENCE TO RELATED APPLICATIONS

This application claims priority from U.S. Provisional Application No. 60/483,541 filed Jun. 26, 2003. U.S. Provisional Application No. 60/483,541 is hereby incorporated by reference in its entirety.

### FIELD OF THE INVENTION

The present invention relates generally to data processing, and more particularly to data totaling operations in a data processing system.

### BACKGROUND

In many purchase and sale transactions, particularly between businesses, the selling party ships product orders on credit, invoicing the purchasing party at time of shipment and offering payment terms according to industry custom. Order management systems are used to maintain information regarding order status and invoice payment, and often include processes for determining whether booking or shipping an order for a given customer will yield a credit exposure (i.e., amount of credit extended) that exceeds the customer's credit limit.

FIG. 1 illustrates an order booking operation in a prior-art order management system. At the start of order booking, the requested item is identified and the cost and availability is determined (101). Assuming that the item is available to be shipped in the desired quantity and within an acceptable lead time, the credit exposure that will result if the order is booked is determined at 103. While many additional factors may be considered, the primary inquiries in the credit exposure determination are (1) how much does the customer presently owe, and (2) how much more will the customer owe when as-yet un-invoiced orders are invoiced, including the order requested to be booked. As shown in the expansion of block 103, these inquiries are handled within the order management system by totaling the outstanding invoices issued to the customer into an invoice total, A (115); totaling any partial payments against the outstanding invoices into a payment total, B (117); totaling the amount of booked, but un-invoiced orders (including the order requested to be booked) into a booked total, C (119); and totaling the costs of the item or items presently being requested (e.g., sale price and applicable tax and freight) into a request total, D (121). The credit exposure is then determined at 123 by summing the booked total, request total and invoice total, less the payment total (i.e., (A−B)+C+D). The credit exposure determined in block 103 is compared with the credit limit at 105. If the credit exposure does not exceed the credit limit, the order is booked at 107. Otherwise the order is declined at 109 until such time as a higher credit limit is negotiated, invoices are paid (lowering the credit exposure) or other arrangements are made.

While the credit exposure determination of FIG. 1 is relatively straightforward, in practice, the credit exposure determination is complicated by a number of additional factors. For example, each of the outstanding invoices and un-invoiced orders typically have multiple associated balances (e.g., for sales price balance, tax, freight, early payment discount, etc.), any one of which may be excluded from the credit exposure determination. Also, orders may be booked in a variety of currencies, each of which may need to be converted to a standard currency on a real-time basis to avoid exchange rate losses. Further, outstanding invoices and un-invoiced orders that fall outside specified time intervals may be excluded from the credit exposure determination. For example, invoices dated after a specified invoice date may be excluded from the credit exposure determination. Similarly, orders not scheduled to ship until after a specified ship date may be excluded from the credit exposure determination. Matters are further complicated by user demand for real-time (e.g., at point-of-sale) selection of the factors to be applied in the credit exposure determination. Thus, users of the order management system may select different rules for determining credit exposure depending on the nature of the requested order.

In low volume applications, all of the above issues may be handled by the order management system in real-time to determine a credit exposure with negligible delay. In larger volume applications, however, the order management system may be required to access massive numbers of database records in order to determine the credit exposure, consuming system resources and resulting in significant delay that reduces the productivity of the system user and, when the credit exposure is determined as part of a customer service activity (e.g., during order booking), is experienced by the customer.

FIG. 2 illustrates a pair of relational database tables that may be used in prior-art approaches to determining credit exposures. In a first approach, referred to herein as online exposure determination, an online orders table 131 (i.e., table into which data is entered during the order booking process) is searched to find orders meeting a particular customer, bill-to site, balance type, currency, and so forth. Although online exposure determination provides full flexibility in determining credit exposures, response times slow noticeably as the orders table 131 grows, and the exposure determination is often unacceptably slow for large volume applications. In a second approach, referred to herein as pre-calculated exposure determination, a pre-calculated balance table 133 is periodically updated based on entries in the orders table 131. The pre-calculated balance table 133 includes balance totals for each customer and bill-to site and for each balance type. For example, all un-invoiced order amounts within the orders table 131 for CompanyA, Site 1 are totaled in a background operation to produce an order amount balance as shown by arrow 136. Totaled tax and freight balances for un-invoiced orders are generated in the same manner from the tax and freight fields within the orders table 131. Also, the order amount, tax and freight fields for all open receivables (orders that have been invoiced, but not fully paid) are totaled, by customer and bill-to site, to generate an open receivables balance as shown at 138, and receipts for open-invoice orders are totaled, by customer and bill-to site to generate a receipt balance as shown at 140. When a credit exposure determination is requested for a given customer, the specified balance types are retrieved from the pre-calculated balance table 133 and summed to determine the credit exposure. Although the pre-calculated exposure determination is fast (i.e., only a few pre-calculated balances need be retrieved at point of sale time), the ability to exclude outstanding invoices and un-invoiced orders that fall outside specified time intervals is sacrificed.

### BRIEF DESCRIPTION OF THE DRAWINGS

The features and advantages of the present invention are illustrated by way of example, and not by way of limitation, in the figures of the accompanying drawings and in which like reference numerals refer to similar elements and in which

FIG. 1 illustrates an order booking operation in a prior-art order management system;

FIG. 2 illustrates a pair of relational database tables used in prior-art approaches to determining credit exposures

FIG. 3 is a timeline of interval subtotals generated according to a flat interval embodiment of the invention;

FIG. 4 illustrates a method of generating a grand total using interval subtotals according to an embodiment of the invention;

FIG. 5 illustrates records in an exemplary interval subtotals table

FIG. 6 is an exemplary a pseudo code listing for population of the table of FIG. 5

FIG. 7 is an exemplary a pseudo code listing for the selection of daily subtotals and for a credit exposure determination

FIG. 8 is a timeline of interval subtotals 275 that are generated according to a hierarchical interval embodiment of the invention;

FIG. 9 illustrates records in an exemplary hierarchical interval table;

FIG. 10 is an exemplary a pseudo code listing for population of the hierarchal intervals table of FIG. 9;

FIG. 11 is a pseudo code listing for selecting interval subtotals from a hierarchical interval table; and

FIG. 12 is a block diagram of a computer system upon which an embodiment of the invention may be implemented.

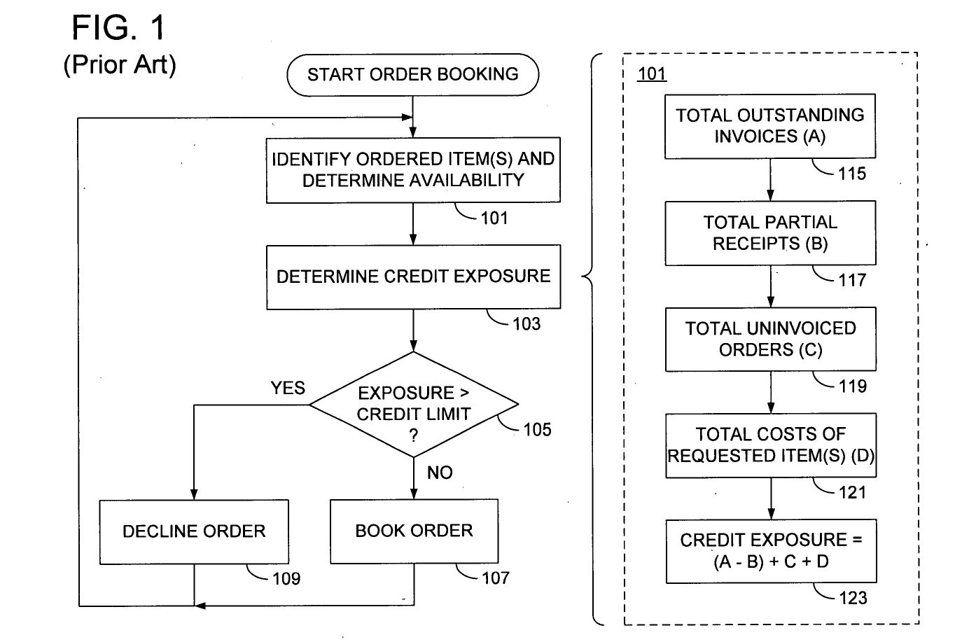

### DETAILED DESCRIPTION

In embodiments of the present invention, totaled values such as credit exposures are determined rapidly and with flexibility to exclude selected ranges of data. In one embodiment, referred to herein as a flat interval embodiment, data values are subtotaled by interval to form interval subtotals that are stored in one or more data storage structures (e.g., relational database tables, hierarchical database storage nodes, etc.). When a grand total is requested, a subset of the interval subtotals that fall within a specified range are selected and totaled to form the grand total. In another embodiment, referred to herein as a hierarchical interval embodiment, the interval subtotals of the flat interval embodiment are totaled into one or more levels of larger interval subtotals, with each level of larger interval subtotals encompassing at least one interval subtotal from the immediately lower level. When requested, a grand total is generated by totaling the largest-interval subtotals falling within the specified range together with interval subtotals from progressively lower levels that fall within the specified range and that are not encompassed by larger interval subtotals that fall within the specified range. These embodiments and others are described in greater detail below in the context of an order management system. In particular, interval subtotals are applied in both the flat and hierarchical interval embodiments to rapidly generate grand totals that represent credit exposures. The embodiments described herein may be applied more generally in any application in which data is associated with a dimension, continuum, progression or other enumeration of values that may be decomposed into distinct intervals (e.g., time, distance, area, volume, frequency, quantity, density, concentration, etc.). Also, while the totals generated in a credit exposure determination are sum totals (or difference totals), numerous other totaling operations may be performed in other applications including, without limitation, determining a superlative value (e.g., minimum, maximum, first, last, youngest, oldest, etc.), determining a statistical value (e.g., mean, median, mode, standard deviation, variance, etc.), determining a count (e.g., number of values that match a selection criterion or number of values within a given table, query set or other data set), or any other operation that may be performed on a set of data values. Thus, herein “totaling”) refers to any operation used to determine a resultant value based on a set of data values, and “total”) refers to the resultant value. Subtotaling refers to a totaling operation on a subset of data from a larger data set. A total may be a scalar value or vector value (i.e., a value having two or more component values). For example, in the case of a subtotal used for determining a totaled average, the subtotal may include a first component indicating the average of a subset of data values, and a second component indicating the number of data values within the subset. Together these components of the subtotal may be used with other subtotaled averages to generate a grand totaled average.

### Generating Grand Totals Using Flat Interval Subtotals

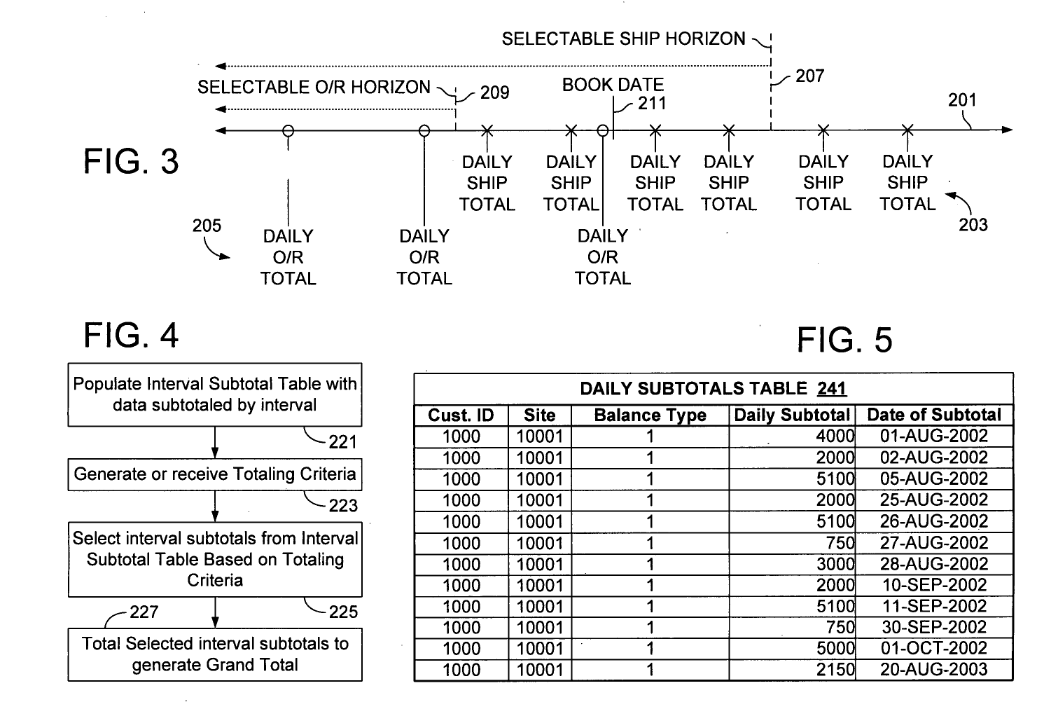

FIG. 3 is a timeline 201 of interval subtotals generated according to a flat interval embodiment of the invention. The interval subtotals include daily ship totals 203 and daily open receivables (O/R) totals 205. Each daily ship total 203 corresponds to a ship date, indicated by an ‘X’ on the timeline 201, and includes a subtotal of balances for all un-invoiced orders scheduled to ship (or that have shipped) on the indicated ship date. As discussed below, separate daily totals may be generated for different un-invoiced order balance types (e.g., order amount, freight, tax, etc.). Each daily O/R total 205 corresponds to an invoice date, indicated by a ‘O’ on the time line 201, and includes a subtotal of balances for all unpaid invoices (i.e., open receivables) issued on the invoice date. When booking an order, a sales agent (or other operator or system) may elect to exclude open receivables not more than a specified number of days old from the credit exposure determination, the specified number of days establishing a date 209 referred to herein as an open receivables horizon, as the open receivables beyond the open receivables horizon (in this case later in time than the open receivables horizon) are excluded from the credit exposure determination. Orders not scheduled to ship until after a specified number of days after the order book date 211 may also be excluded from the credit exposure determination, the specified number of days establishing a date 207 referred to herein as a ship horizon, as un-invoiced orders scheduled to ship after the ship horizon are excluded from the credit exposure determination. As an example, if a customer is typically offered thirty day payment terms, invoices not more than 30 days old as of the book date 211 may be considered current and excluded from the credit exposure determination by selecting a 30-day open receivables horizon 209 (or by specifying a date for the open receivables horizon). Similarly, if a fifteen day ship horizon is selected, all orders scheduled to ship more than fifteen days after the book date are excluded from the credit exposure determination. Assuming that a selected open receivables horizon 209 and ship horizon 207 are as shown in FIG. 3, only the daily open receivables totals 205 to the left of the open receivables horizon, and the daily ship totals 203 to the left of the ship horizon are included in the credit exposure determination.

FIG. 4 illustrates a method of generating a grand total using interval subtotals according to an embodiment of the invention. At 221, an interval subtotal table is populated by subtotaling data by interval, then inserting the interval subtotals into respective rows of the interval subtotal table. The source of subtotaled data may be another table or data structure within the same system, data received via a communication interface, generated data (e.g., data generated by processes, sensors or transducers, etc.) or any other source of data. In the case of an order management system, the source of subtotaled data may be an orders table maintained within the system (or within a network accessible to the system) and queried by customer, customer site, balance type and scheduled ship date and/or invoice date.

FIG. 5 illustrates records in an exemplary interval subtotals table 241 that correspond to a selected customer (customer ID=1000), customer site (site=10001), and balance type (balance type=1). Assuming for the purpose of example, that balance type 1 corresponds to un-invoiced order amounts and that the subtotal intervals are single-day intervals, then the un-invoiced balances from an orders table are summed according to scheduled ship dates to form daily subtotals. Because single-day intervals are used, the table 241 is referred to herein as a daily subtotals table. Each daily subtotal is inserted into a respective record of the daily subtotals table along with the date of the subtotal. In one embodiment, daily subtotals for open receivables balance types (e.g., invoiced amounts, payments against invoices) are inserted into the same table as daily subtotals for un-invoiced order balance types (e.g., order amounts, freight, tax, etc.), the date of total indicating an invoice date in the case of open receivables balance types and a ship date in the case of un-invoiced order balance types. In an alternative embodiment, separate tables may be maintained for open receivables subtotals and un-invoiced order subtotals, and separate tables may be maintained for different open receivables balance types and/or for different un-invoiced order balance types.

Still referring to FIG. 5, it should be noted that intervals longer or shorter than a day may be used in alternative embodiments, depending on the subtotal granularity desired. Also, while equal-length intervals are used for the interval subtotals, intervals of unequal lengths may be used in alternative embodiments. Further, the intervals are non-overlapping and therefore said to be flat intervals. Partially or fully overlapping intervals may be used in alternative embodiments, a number of which are discussed below.

Returning to FIG. 4, in one embodiment, the population of the interval subtotal table is performed by a background process that is launched automatically at regular intervals, or in response to selected events (e.g., in response to a predetermined number of updates to the orders table, in response to an explicit execution command, etc.). In general, a background process is a program execution without substantial user interaction and that uses less than all available processing capability of the system processing entity, thereby enabling other processes, particularly those that interact with human operators and/or other systems, to continue to execute. Other types of processes may be used to populate the interval subtotal table in alternative embodiments.

Once populated by the operation at 221, the interval subtotal table is available for use in grand totaling operations. A grand totaling operation begins with receipt or generation of totaling criteria, if any, at block 223. In the case of a credit exposure determination, the totaling criteria may include any number of user-provided or user-selected criteria including, without limitation, a customer identifier, customer site identifier (i.e., for customers having multiple bill-to and/or ship-to sites), one or more balance types, currency type, open receivables horizon and/or ship horizon. In other applications, different criteria may be provided or selected by the user, or criteria may be generated by sensors, transducers, or other data generation devices or systems.

Still referring to FIG. 4, after the totaling criteria is obtained in block 223, the totaling criteria is used to select interval subtotals from the interval subtotal table in block 225. The selected interval subtotals are than totaled in block 227 to generate the grand total. Applying the operations of blocks 223, 225 and 227 to the daily subtotals table 241 of FIG. 5, if a ship horizon of Aug. 6, 2002 is specified in block 223, the daily subtotals of records having ship dates that precede the ship horizon are selected in block 225 (i.e., records having Date of Subtotal values Aug. 1, 2002, Aug. 2, 2002 and Aug. 5, 2002), and the selected interval subtotals (4000, 2000 and 5100) are summed to generate a credit exposure in block 227.

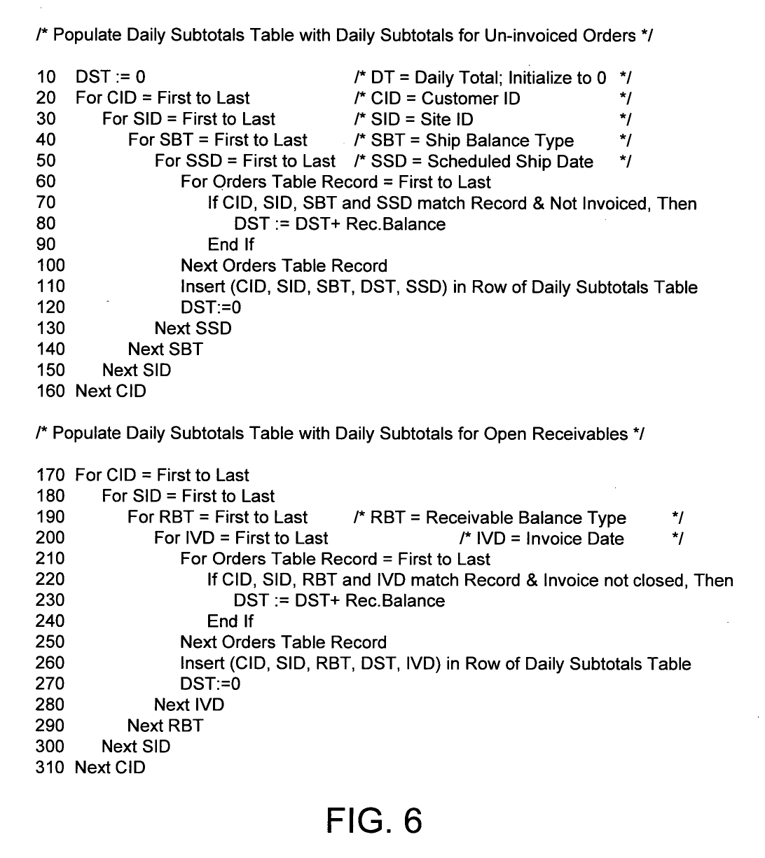

FIG. 6 is an exemplary a pseudo code listing for population of the daily subtotals table 241 of FIG. 5, though the operations described may readily be applied to populate other type of interval subtotal tables. The pseudo code statements in FIG. 6 and other figures herein are numbered by line number for ease of reference and, while including comment fields (opened and closed by ‘/*’ and ‘*/’, respectively) and syntactical constructs such as FOR loops and IF statements, are not presented in a specific programming language. The operations expressed may be implemented using procedural programming languages (e.g., BASIC, C, Pascal, COBOL, PL/M, etc.), object-oriented programming languages (Modula, C++, Java, etc.), database programming languages (e.g., structured query languages (SQL)) or virtually any other type of code that can be compiled or translated into machine-executable instructions. As discussed below, the operations expressed in the pseudo code listings herein may also be carried out in a hardware implementation, or any combination of programmed machine and hardwired circuitry.

The pseudo code statements numbered 10-160 correspond to operations used to populate the daily subtotals table with daily subtotals for un-invoiced order balance types (e.g., order amounts, freight, tax), and the pseudo code statements numbered 170-310 correspond to operations used to populate the daily subtotals table with daily subtotals for open receivables balance types (e.g., invoice amounts, payments against invoices). Starting with line 10, a daily subtotal variable, DST, is initialized to zero. Lines 20 and 160 define a FOR loop in which a customer ID (CID) is incremented from a first customer ID to a last customer ID, with each customer ID being applied in the operations within the body of the loop (i.e., lines 30-150). The FOR loop defined by lines 20 and 160 is therefore referred to in short as the customer ID loop. Lines 30 and 150 define a FOR loop for the site ID (SID) nested within the customer ID loop; lines 40 and 140 define a FOR loop for the un-invoiced order balance types (referred to herein for brevity as ship balance types (SBT)) nested within the site ID loop; lines 50 and 130 define a FOR loop for the scheduled ship date (SSD, the interval for which a subtotal is to be generated) nested within the ship balance type loop; and lines 60 and 100 define a FOR loop for the records of the data source from which values are to be subtotaled (the orders table in this example), nested within the scheduled ship date loop. At line 70, the loop values for the customer ID, site ID, ship balance type, and scheduled ship date are compared with the corresponding fields of a selected orders table record. If the fields of the record match the respective loop values and the record indicates that the order has not been invoiced (e.g., an invoice-date field of the record is null), then at line 80, the balance maintained within the orders table record (Rec.Balance) is accumulated in the daily subtotal variable. That is, the daily subtotal variable, DST, is assigned its present value plus the record balance, the assignment being indicated in line 80 by the assignment operator ‘:=’. At line 110, after each applicable balance of the orders table (i.e., the balance of each orders table record having a customer ID, site ID, balance type and scheduled ship date that match the loop values) has been accumulated in the daily subtotal variable, the daily subtotal operation is completed for the loop values of the customer ID, site ID, balance type and scheduled ship date, and the loop values and daily subtotal are inserted into a row of the daily totals table (i.e., forming a new record within the daily totals table). Alternatively, the loop values and daily subtotal may be stored in a temporary table or other data structure until all such daily subtotals are generated, then a complete set of records committed to the daily subtotals table in a single commit operation. In either case, the daily subtotal variable is cleared at line 120 in preparation for the next iteration of the scheduled ship date loop. It should be noted that the customer ID, site ID, ship balance type and scheduled ship date loops may be nested in different orders in alternative embodiments to achieve different groupings of records within the daily subtotals table.

Lines 170 to 310 of FIG. 6 define operations that parallel those of lines 20 to 160, except that a receivables balance type loop is executed (i.e., at lines 190 and 290) instead of a ship balance type loop; an invoice date FOR loop is executed (i.e., at lines 200 and 280) instead of a scheduled ship date loop; and the IF statement at line 220 tests for a matching invoice date instead of a matching scheduled ship date, and for a non-closed invoice instead of a non-invoiced order. When the final customer ID has been processed in lines 170-310, the daily subtotals table is populated with respective daily subtotals, grouped by customer, customer site and balance type, for each scheduled ship date and each invoice date.

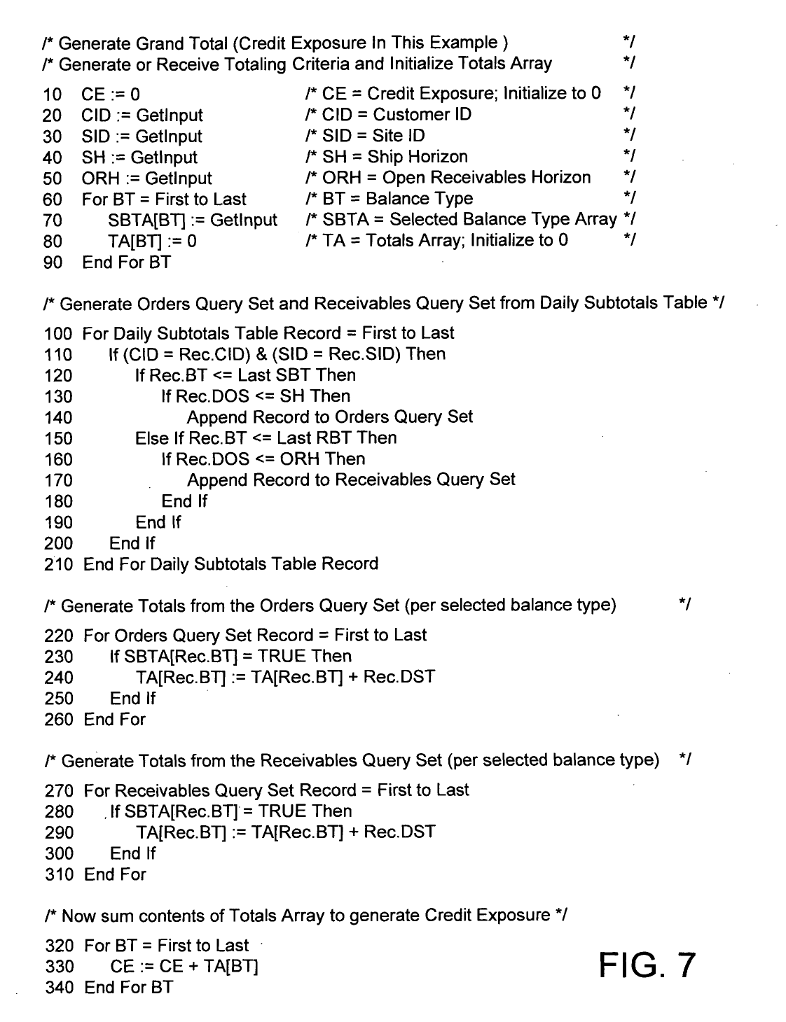

FIG. 7 is an exemplary a pseudo code listing for the selection of daily subtotals and for a credit exposure determination that correspond, respectively, to the selection operation 225 and grand totaling operation 227 of FIG. 4. In line 10, a credit exposure variable, CE, is initialized to zero, and in lines 20-50, user-input variables, customer ID (CID), site ID (SID), ship horizon (SH) and open receivables horizon (ORH), are set according to user input or other data source (e.g., a user-selected set of such values). In lines 60 to 90, a FOR loop is executed to initialize entries in a totals array (TA) to zero, and to assign true/false values to entries of a selected balance type array (SBTA) according to which balance types are selected (e.g., by a user) for inclusion in the credit exposure determination. The totals array and the selected balance type array are dimensioned according to the number of balance types used in the system, and therefore are indexed by a balance type variable, BT, which is incremented from a first balance type to a last balance type by the FOR loop of lines 60 and 90.

In lines 100-210, the daily subtotals table is queried to select a set of records that match the user-input variables, the selected set of records being referred to herein as an orders query set. More specifically, lines 100 and 210 define a For loop for sequential retrieval of records from the daily subtotals table. At line 110, the customer ID and site ID values within the retrieved record, Rec.CID and Rec.SID, are compared with the corresponding user-input variables, CID and SID. If the record values match the user-input variables, then if the record balance type, Rec.BT, is a ship balance type (determined at line 120) and the record day-of-subtotal (Rec.DOS) does not exceed the ship horizon (determined at line 130), then the record is appended to (or added to or otherwise included in) the orders query set at line 140. If the record balance type is not a ship balance type, then the operations at lines 130 and 140 are skipped, and the record balance type is evaluated at line 150 to determine if it is a receivables balance type. If the record is a receivables balance type and if the record day-of-subtotal does not exceed the open receivables horizon (determined at line 160), then the record is appended to the receivables query set at line 170.

After the last record of the daily subtotals table is processed within the FOR loop defined by lines 100 and 210, each of the daily subtotals applicable to the specified credit exposure determination is included within either the orders query set or receivables query set. In lines 220-260, the balance type of each record within the orders query set (Rec.BT) is used to index the selected balance type array, SBTA, to determine if the record balance type is selected for inclusion in the credit exposure determination. That is, if SBTA[Rec.BT]=TRUE, then the balance type is selected for inclusion. If the record balance type is selected for inclusion, then at line 240 the daily subtotal for the record, Rec.DST, is accumulated in the appropriate entry within the totals array, TA[Rec.BT].

Still referring to FIG. 7, lines 270-310 apply to the receivables query set in the same way that lines 220-260 apply to the orders query set. That is, in lines 270-310, the balance type of each record within the receivables query set is used to index the selected balance type array to determine if the record balance type is selected for inclusion in the credit exposure determination. If so, then at line 290 the daily subtotal for the record, Rec.DST, is accumulated in the appropriate entry within the totals array, TA[Rec.BT].

In the pseudo code statements numbered 320-340, the content of the totals array for each balance type is accumulated within the credit exposure variable, CE, to complete the credit exposure determination.

Reflecting on the component operations set forth in FIG. 7, it should be noted that generation of the orders query set and receivables query set are intermediate operations that may be omitted. For example, each record of the daily subtotals table selected for inclusion in the orders query set (i.e., at line 140) may instead be used to directly update the totals array as shown at line 240. Similarly, each record of the daily subtotals table selected for inclusion in the receivables query set (i.e., at line 170) may instead be used to directly update the totals array as shown at line 290. Numerous other changes may be made in the sequence of events and data structures set forth in FIG. 7 without departing from the spirit and scope of the present invention.

### Generating Grand Totals Using Hierarchical Interval Subtotals

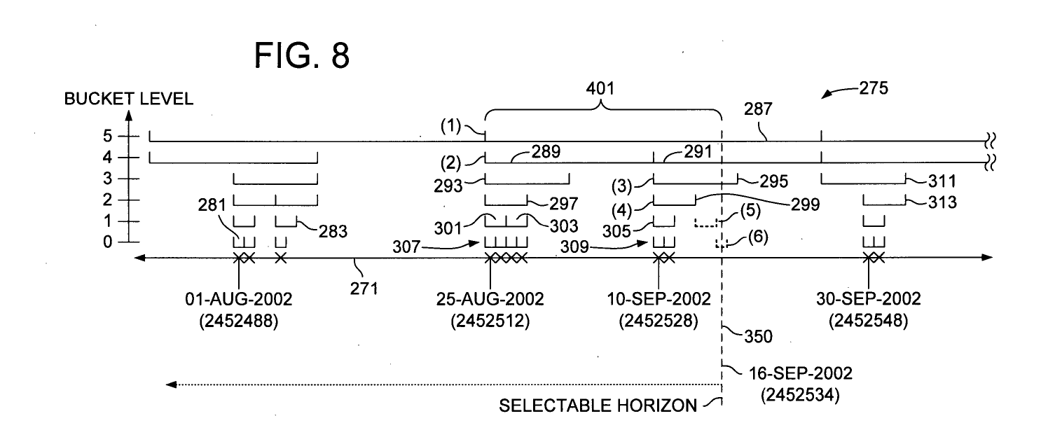

FIG. 8 is a timeline 271 of interval subtotals 275 that are generated according to a hierarchical interval embodiment of the invention. The interval subtotals 275 are arranged in a hierarchy of levels, with the interval subtotals for each level corresponding to an interval that is longer than the interval length for the immediately lower level. In the embodiment of FIG. 8, the intervals at each level are twice as long as-the intervals in the level immediately below, thereby establishing a binary hierarchy. Other relationships between the interval lengths at different levels may be used in alternative embodiments.

In one embodiment, a data construct referred to herein as a bucket is used to define each interval subtotal 275, with each bucket having a subtotal component (referred to herein as a bucket total) and an interval definition component. The interval definition component itself includes a bucket number and bucket length, the bucket length indicating the duration of an interval that starts at a point in time indicated by the bucket number. In one embodiment, integer values corresponding to Julian calendar dates (i.e., a continuous count of days since Jan. 1, 4713 BCE (Before Common Era)) are used to represent bucket numbers, and integer values corresponding to a number of days are used to represent bucket lengths. For example, a bucket 281 dated Aug. 1, 2002 and spanning a one-day interval may be expressed as bucket number 2452488, length 1 or, for brevity, bucket [2452488, 1]. Similarly, a bucket 295 dated September 10, 2002 and spanning an eight-day interval may be expressed as bucket ([2452528, 8].

In the exemplary binary hierarchy of FIG. 8, each bucket belongs to a bucket level according to its length, where the bucket length and bucket level have the following relationship:

Bucket Length=2^{Bucket Level} days

Thus, buckets at level zero have a length of 1 day, buckets at level one have two-day lengths, buckets at level 2 have four day lengths and so forth. Also, in the embodiment of FIG. 8, each bucket at a given level encompasses at least one lower-level bucket (e.g., each level-one bucket encompasses at least one level-zero bucket, each level-two bucket encompasses at least one level-one bucket, and so forth) and the bucket total for a bucket at a given level is a total of the subtotal components of the encompassed buckets at the next lower level. Thus, the bucket total for level five bucket 287 constitutes a total of the bucket totals for level four buckets 289 and 291, and may additionally be viewed as a total of the bucket totals for level three buckets 293 and 295, or a total of the level two buckets 297 and 299, or a total of the bucket totals for level one buckets 301, 303 and 305, or a total of the bucket totals for level zero buckets shown generally at 307 and 309.

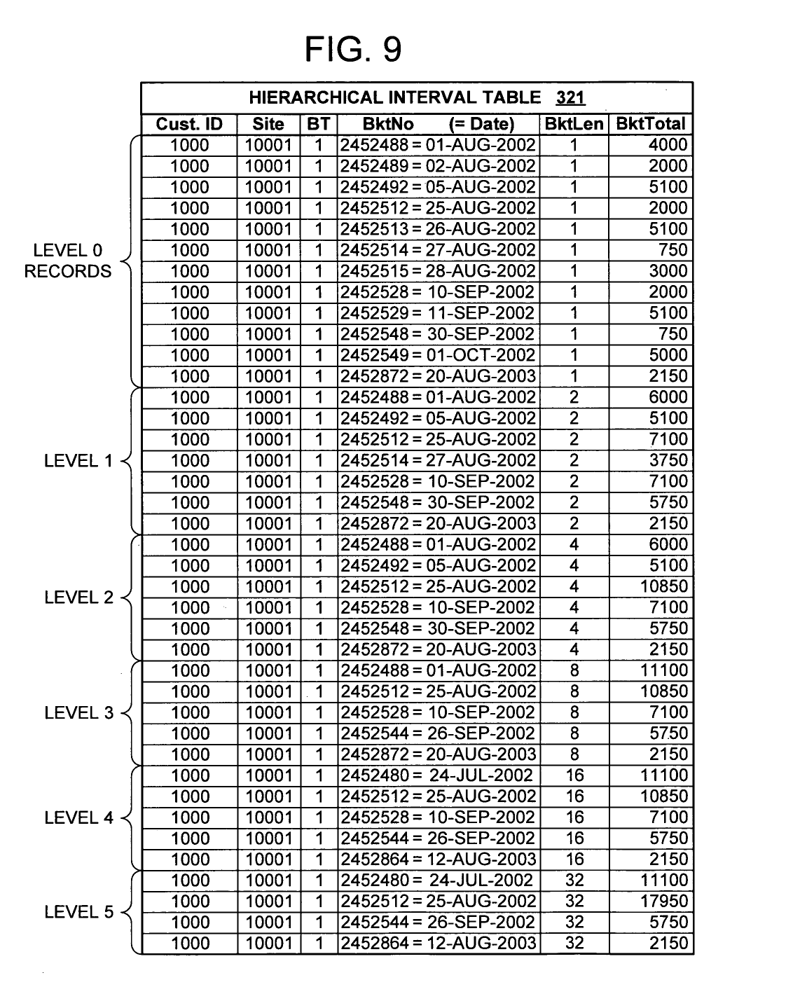

FIG. 9 illustrates records in an exemplary hierarchical interval table 321 that corresponds to a selected customer (customer ID=1000), customer site (site=10001), and balance type (BT=1). Other columns may be included in alternative embodiments (e.g., currency type, sales agent, discount terms, etc.). Each record also includes a bucket defined by a bucket number, BktNo (with the indicated date shown in both Julian and day-month-year formats for convenience of reference herein), bucket length, BktLen, and bucket total, BktTotal. The records for level-zero buckets (i.e., level-zero records) correspond to ship dates marked by ‘X’ on the timeline 271 of FIG. 8 (separate buckets may be provided for receivables balance types). Thus, the first level-zero record corresponds to the Aug. 1, 2002 ship date of FIG. 8, and therefore has bucket number 2452488 and a bucket length of 1 (i.e., bucket ([2452488, 1]). Bucket [2452488, 1] has an exemplary bucket total of $4000, representing the subtotal of order amounts (or other ship balance types) for orders scheduled to ship on Aug. 1, 2002. The second level-zero record has bucket number 2452488 (Aug. 2, 2002), a bucket length of 1, and an exemplary bucket total of $2000; the third level-zero record has bucket number 2452489 (Aug. 5, 2002), a bucket length of 1, and an exemplary bucket total of $5100; and so forth. Note that the final level-zero record has bucket number 2452872 (Aug. 20, 2003) and is not shown on the timeline of FIG. 8.

Each of the level-one records has a bucket length of 2, with the first level-one record having bucket number 2452488 (Aug. 1, 2002) and therefore encompassing (or spanning) the two day interval from Aug. 1, 2002 to Aug. 2, 2002. Accordingly, bucket [2452488, 2] has a bucket total that is an accumulation of the bucket totals of level-zero buckets [2452488, 1] and [2452489, 1], or $6000. The second level-one record has bucket number 2452492 and therefore encompasses the two-day interval from Aug. 5, 2002 to Aug. 6, 2002. Because only a single level-zero bucket, [2452492, 1], is encompassed by bucket [2452492, 2], the bucket total for bucket [2452492, 2] is the same as the total for the encompassed level-zero bucket (i.e., $5100). The rest of the level-one buckets listed in the hierarchical interval table 321 similarly encompass either one or two level-zero buckets and have respective bucket totals that are an accumulation of the bucket totals for the encompassed buckets. The level-two buckets similarly encompass either one or two level-one buckets and have respective bucket totals that are an accumulation of the bucket totals for the encompassed level-one buckets; the level-three buckets encompass either one or two level-one buckets hand have bucket totals that are an accumulation of the bucket totals for the encompassed level-two buckets; and so forth to the level N buckets which each encompass either one or two buckets at level N−1 and have respective bucket totals that are an accumulation of the bucket totals for the encompassed buckets. In this example, N=5, although more or fewer levels may be used in alternative embodiments. (Also, a system administrator or other operator may select or specify the number of levels in a preference setting or other configuration value.) Thus, the first level-five bucket [2452480, 32] encompasses a single level four bucket [2452480, 16] which encompasses a single level-three bucket [2452488, 8] which encompasses two level-two buckets [2452488, 4] and which collectively encompass two level-one buckets [2452488, 2] and [2452492, 2] which collectively encompass three level-zero buckets [2452488, 1], [2452489, 1] and [2452492,1]. Thus, the bucket total for level-five bucket [2452480, 32] represents an accumulation of all the encompassed buckets within any single lower level; an accumulation of $11100 in this example.

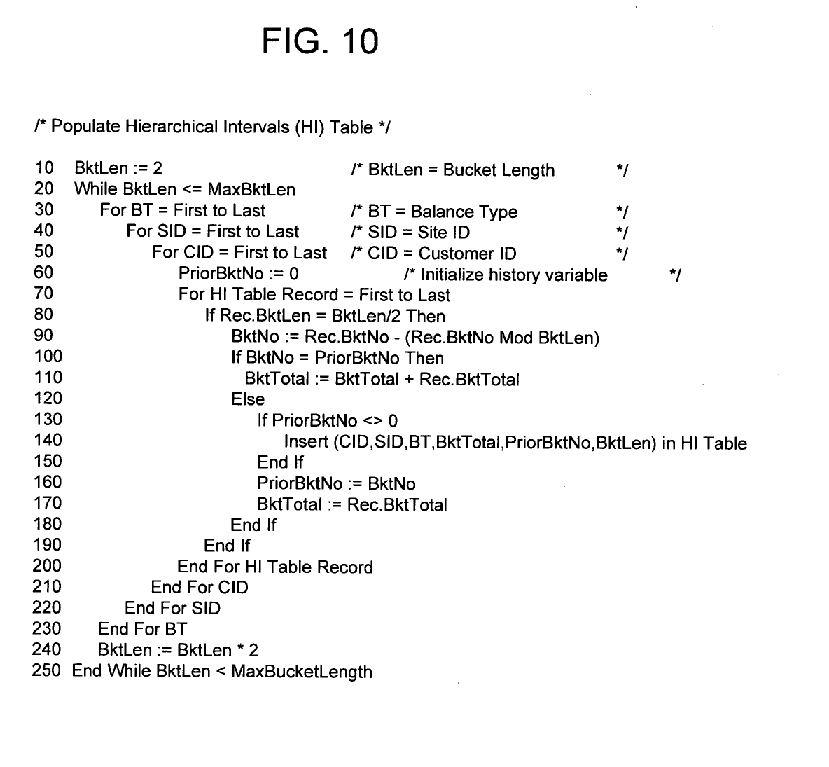

The flow diagram of FIG. 4 applies generally to the hierarchical interval arrangement of FIG. 8, with changes primarily in the details of interval table population (block 221) and subtotaled data selection (block 225). FIG. 10, for example, is an exemplary a pseudo code listing for population of the hierarchal intervals table of FIG. 9. The hierarchical interval table is initially populated with zero-level buckets (i.e., daily buckets) for each balance type using, for example, the approach described in reference to FIG. 6. Note that the insertion operations at lines 110 and 260 of FIG. 6 will be applied to the hierarchical interval table rather than the daily subtotals table, and the inserted records will include a bucket length of 1.

At line 10 of FIG. 10, a bucket length variable, BktLen, is initialized to 2; the bucket length for the next-level records to be populated. Lines 20 and 250 define a WHILE loop in which lines 30-240 are executed iteratively until BktLen exceeds a maximum bucket length, MaxBktLen. Lines 30 and 230 define a FOR loop in which a balance type variable (BT) is incremented from a first balance type to a last balance type, with each balance type being applied in the operations of lines 40-220. Lines 40 and 220 similarly define a FOR loop for a customer ID variable (CID), and lines 50 and 210 define another FOR loop for a site ID variable (SID). Thus, the operations of lines 60-200 are executed for each combination of customer ID, site ID and balance type. As discussed in reference to FIG. 6, the nesting of FOR loops may be rearranged to change record groupings, and additional nested FOR loops may be provided to enable subtotals to be separated by other qualifying criteria, such as currency type, sales agent, etc.

At line 60, a history variable, PriorBktNo, that represents the bucket number for a prior iteration of the operations in lines 70-200 is initialized to zero. Lines 70 and 200 define a FOR loop for sequential selection of the previously loaded records (i.e., the level-zero records in the first iteration) of the hierarchical interval table and for generation of higher level buckets. In the IF statement at line 80, the bucket length of the selected record, Rec.BktLen, is compared with BktLen/2 to determine if the level of the selected record is one below the record level presently being populated. If so, then the operations at lines 90-170 are executed to generate a new bucket or to include the bucket total for the selected record in a new bucket generated in a prior iteration of lines 90-170. If the level of the selected record is not one below the record level being populated, then the next record of the hierarchical interval table is retrieved at line 70 and the IF statement at line 80 is re-executed. If a new bucket is to be generated (i.e., Rec.BktLen is determined to equal BktLen/2 at line 80) then a bucket number for the new bucket is assigned to a bucket number variable, BktNo, at line 90. In the embodiment of FIG. 10, the new record is assigned the bucket number of the selected record, Rec.BktNo, less the integer remainder of Rec.BktNo divided by the bucket length variable, BktLen (i.e., Rec.BktNo Mod BktLen, where Mod is the modulus operator). By this operation, if the bucket number of the selected record is divided evenly (i.e., without remainder) by the length of the new bucket, BktLen, then the new bucket is assigned the same bucket number as the lower level bucket such that the new bucket is start-date aligned with the lower level bucket. As an example, buckets 293 and 297 of FIG. 8 are start-date aligned. If the bucket number of the selected record is not divided evenly by the new bucket length, then the new bucket is assigned a bucket number that precedes Rec.BktNo by the length of the lower level bucket (Rec.BktLen), so that the new bucket is end-date aligned with the lower level bucket. As an example, buckets 311 and 313 of FIG. 8 are end-date aligned. Different approaches to bucket number assignment may be used in alternative embodiments.

During each iteration of the FOR loop at line 70 that results in generation of a bucket number, the bucket number is recorded in the history variable, PriorBktNo, for use in a subsequent iteration. If two same-level records of the hierarchical interval table yield the same bucket number at line 90, then the buckets are adjacent one another, represent a continuous span of time, and will be encompassed by the same higher level bucket. For example, level-one buckets 301 and 303 of FIG. 8 will each yield the same bucket number, 2452512, during population of level-two records. Thus, the IF statement at line 100 is executed to determine whether the bucket number generated at line 90 equals a previously generated bucket number. If so, the bucket total for the selected record is accumulated into the BktTotal variable (i.e., at line 110) which, by virtue of line 170, already contains the total for the record selected in the previous iteration of the line-70 FOR loop. After the bucket total is accumulated at line 110, the next record of the hierarchical interval table is selected for another iteration of lines 70-190. If the bucket number generated at line 90 is determined not to match the prior bucket number, then the bucket processed in a previous FOR loop iteration is complete and the operations included within the line 120 ELSE statement are performed. Specifically, at line 130, the history variable, PriorBktNo, is compared with zero to determine if this is the first iteration of the line 70 FOR loop. If PriorBktNo is nonzero, then the bucket total and bucket number assignments made in the prior iteration of the line 70 FOR loop (i.e., PriorBktNo and BktTotal) correspond to a completed bucket which is inserted into a record of the hierarchical interval table at line 140, along with the bucket length value, BktLen, and the loop values of the customer ID, site ID and balance type. If PriorBktNo is zero, then no table insertion is performed, as there was no prior iteration of the line-70 FOR loop and the bucket number and bucket total may correspond to an incomplete bucket. At line 160, the bucket number generated at line 90 is assigned to the history variable, PriorBktNo, and at line 170, the bucket total variable is assigned the value of the bucket total for the selected record. By these operations, the BktTotal variable is prepared for the accumulation operation at line 110 (i.e., in a subsequent iteration of the line-70 FOR loop), and the PriorBktNo variable is prepared for the comparison operations at line 100 and 130, and the insertion operation at line 140.

After the above described operations have been carried out for each combination of balance type, site ID, and customer ID (and possibly other loop variables, such as currency type, sales agent, etc.), the bucket length is doubled at line 240 to enable generation and insertion of the next-level records. By this operation the records for each bucket level are generated based on the records for the prior bucket level. After the bucket length for the final level is applied, the bucket length is again doubled at line 240, resulting in exit from the WHILE loop defined by lines 20 and 250. At this point, the hierarchical interval table is populated with interval totals for each bucket level.

In one embodiment the record insertion at line 140 is directed to an intermediate structure (e.g., a temporary table) with the contents of the intermediate structure being committed to the hierarchical interval table at the conclusion of the outermost FOR loop of FIG. 10 (i.e., the loop defined by lines 30 and 230). By this arrangement, the records generated for a given bucket level are stored within the hierarchical interval table for selection during the generation of next-level records. In an alternative embodiment, the intermediate structure is populated with records for all bucket levels, including the lowest level buckets, before the contents of the intermediate structure is committed to the hierarchical interval table. In such an embodiment, the FOR loop defined by line 70 and 200 is used to select records from the intermediate structure instead of the hierarchical interval table.

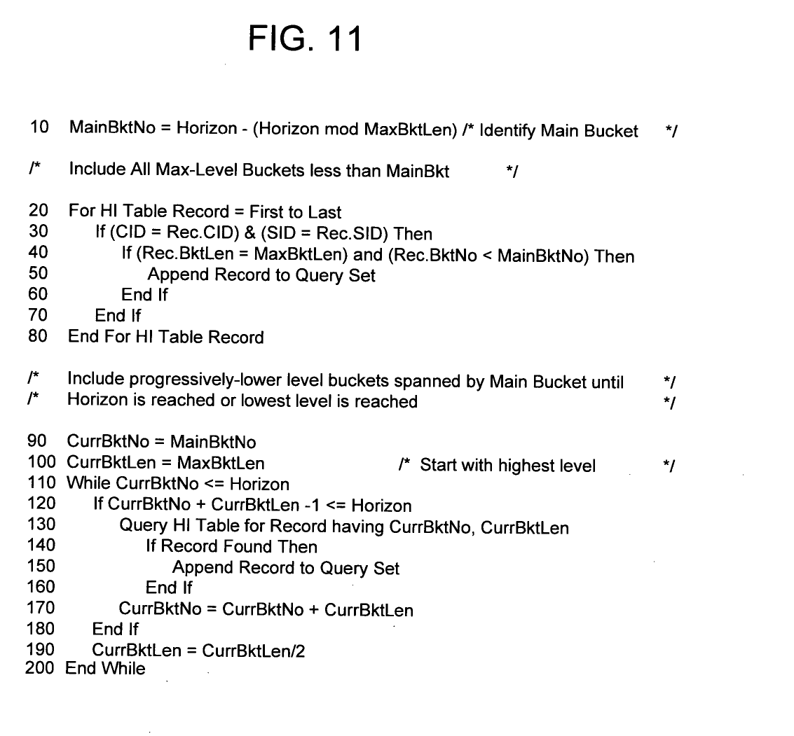

FIG. 11 is a pseudo code listing for selecting interval subtotals from a hierarchical interval table based on a single, generalized horizon date. In actual implementation, the approach of FIG. 11 may be applied for multiple horizon dates (e.g., separate ship and receivables horizon dates). Also, while the hierarchical interval table may be populated with interval totals for multiple different balance types, a single balance type is assumed in the pseudo code listing of FIG. 11. Additional FOR loops may be provided in the manner described above to handle the various balance types selected to contribute to determination of a credit exposure or other totaled value.

At line 10, a main bucket that encompasses the horizon date is identified by dividing the horizon date (i.e., a Julian value, HORIZON) by the maximum bucket length (MaxBktLen), then subtracting the remainder from the from the horizon date. Referring to FIG. 8, for example, if the horizon date corresponds to dashed line 350, then integer division of the horizon date by 32 (the maximum bucket length in this example), yields a remainder that corresponds to the number of days between the horizon date 350 and the start of level-five bucket 287. Accordingly, the bucket number for the level-five bucket 287 (i.e., bucket number 2452512) is obtained by subtracting the remainder from the horizon date 350. As bucket 287 encompasses the horizon date 350, it is the desired main bucket.

Still referring to FIG. 8, it can be seen that the bucket totals for each of the highest-level buckets (i.e., the level-five buckets in this example) to the left of the main bucket 287 may be summed to generate a total for an interval that extends from the oldest daily bucket to the main bucket. This interval is referred to herein as the approach interval as it approaches, but does not necessarily reach the horizon date. Accordingly, in FIG. 11, each record of the hierarchical interval table is selected in the FOR statement defined by lines 20 and 80; evaluated at line 30 to determine if the customer ID and site ID match selection values CID and SID (e.g., the values selected in lines 20 and 30 of FIG. 7); and then evaluated at line 40 to determine if the bucket length of the record matches the maximum bucket length and to determine if the bucket number of the record is less than the main bucket number. Assuming that the record matches the selection criteria at line 30, then if the bucket length matches the maximum bucket length and bucket number of the record is less than the main bucket number, then the record corresponds to a highest-level bucket that precedes the main bucket in time. Accordingly, at line 50, the record is appended to a query set for use in a later totaling operation.

Referring to FIG. 8, after all the applicable highest-level buckets are recorded in the query set, progressively lower level buckets that span the interval 401 between the start of the main bucket and the horizon date (i.e., the remainder interval) are selected for inclusion in the query set. In the exemplary pseudo code listing of FIG. 11, the remainder interval is treated in lines 90-200. At lines 90 and 100, current bucket number and current length variables (CurrBktNo and CurrBktLen) are assigned the bucket number and length, respectively, of the main bucket (the maximum bucket length, MaxBktLen being the length of the main bucket). A WHILE loop defined by lines 110 and 200 is then repeated until the current bucket number is assigned a value that exceeds the horizon date. At line 120, the end date for the current bucket number (i.e., CurrBktNo+CurrBktLen) is compared with the horizon date to determine whether the current bucket (i.e., bucket having the current bucket and length) extends beyond horizon date. If not, then the hierarchical interval table is queried (or searched) for a record having the current bucket number and current bucket length. If such a record is found, the record is appended to the query set at line 150. If no bucket matching the current bucket number and current length is found in the hierarchical interval table, then no such bucket exists and, consequently, the append operation at line 150 is skipped. In either case (i.e., matching record found or not), the current bucket number is summed with the current bucket length at line 170 to generate an updated current bucket number. The current bucket number generated at line 170 is ensured to precede the horizon date (i.e., have a lower number than the horizon) by virtue of the IF statement at line 120. At line 190, the current bucket length is halved so that the next bucket tested at the line 120 IF statement is one level lower and one half as long than the bucket tested in the prior iteration. By this operation, buckets at progressively lower levels are added to the query set until the lowest level bucket is reached.

FIG. 8 illustrates the manner in which buckets in the remainder interval are selected by the operations described in reference to FIG. 11. For example, assuming that in the first iteration of the WHILE loop defined by lines 110 and 200, the current bucket is the bucket indicated in FIG. 8 at (1) (i.e., bucket 287). Because the current bucket (1) extends beyond the horizon date (Sep. 16, 2002 in this example; Julian number 245234), execution of the IF statement at line 120 excludes the current bucket from the query set, and the current bucket length is halved at line 190 in preparation for the next WHILE loop iteration. Accordingly, in the second iteration of the WHILE loop, the current bucket is the bucket indicated at (2). Because the current bucket (2) does not extend beyond the horizon date, the record corresponding to bucket (2) is found in the hierarchical interval table at line 130 and appended to the query set at line 150. The bucket (3) is then assigned to be the current bucket by virtue of the operations at lines 170 and 190. In the third iteration of the WHILE loop, bucket (3) is excluded from the query set (i.e., because the bucket extends beyond the horizon date), and bucket (4) is assigned to be the current bucket by execution of line 190. In the fourth iteration of the WHILE loop, bucket (4) is determined not to extend beyond the horizon date, and is therefore found in the hierarchical interval table at line 130 and appended to the query set at line 150. The current bucket is then assigned to be the bucket (5). Bucket (5) is shown in dashed outline to emphasize its non-existence in the hierarchical interval table, and is referred to herein as a phantom bucket. That is, there is no record in the hierarchical interval table associated with bucket (5), but this fact is not determined until the hierarchical interval table is queried at line 130. Thus, in the fifth iteration of the WHILE loop, bucket (5) is determined to not to extend beyond the horizon date, and therefore the query operation at line 130 is performed to determine whether a record for bucket (5) exists. Because no record for bucket (5) exists, the append operation at line 150 is skipped, and the current bucket is assigned to be the phantom bucket (6). In the sixth iteration of the WHILE loop, bucket (6) is determined not to extend beyond the horizon date, and therefore the query operation at line 130 is performed to determine whether a record for bucket (6) exists. Because no record for bucket (6) exists, the append operation at line 150 is skipped, and the current bucket number is assigned, at line 170, to be the bucket number of bucket (6), plus one. Because the bucket number of bucket (6) matches the horizon date, the bucket number assignment at line 170 in the sixth iteration of the WHILE loop yields a current bucket number that exceeds the horizon date. Thus, when the WHILE loop exit condition is next tested at line 110, the WHILE loop is exited.

After the query set has been formed by the operations at lines 10-200 of FIG. 11, grand total values may be generated in the manner described in reference to lines 220-340 of FIG. 7. For example, separate orders and receivables query sets may be generated by separate executions of the FIG. 11 operations (i.e., for different ship and O/R horizon dates) and then applied in the totaling operations of lines 220-260 and 270-310, respectively, of FIG. 7.

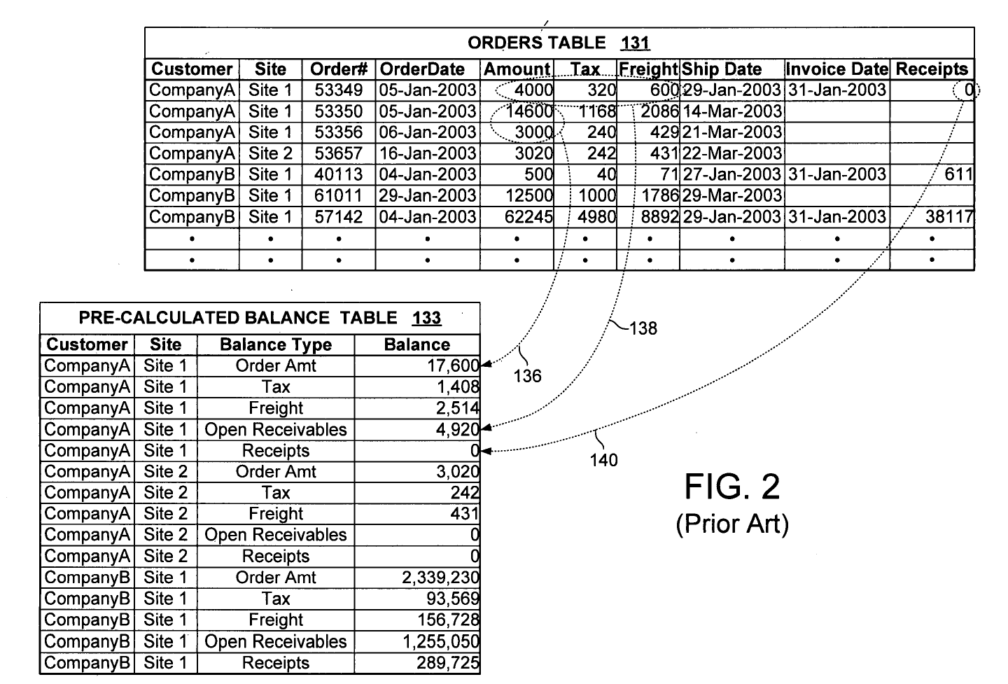

Reflecting on FIG. 11, it can be seen that the overall number of records included in the query set is equal to the number of highest-level records appended to the query set to span the approach interval, plus the number of records appended to the query set to span the remainder interval (i.e., the number of records at progressively lower levels needed to converge to the horizon date). In an order management database populated with having numerous records per day, the use of high-level buckets to generate an interval total that encompasses all the balances within the approach interval represents a substantial record selection savings. That is, each highest-level bucket appended to the query set in line 50 represents a savings of as many as M*(2^{N}−1) append operations as compared to the flat interval approach of FIGS. 6 and 7, where M is the number of balance types to be applied, and N is the number of hierarchical interval levels (i.e., bucket levels). For example, if N=12, and M=5 (e.g., three orders balance types: amount, freight, tax; and two receivables balance types: invoice amount, payment amount), then as many as 12²*5=20,480 daily subtotals records may need to be retrieved and totaled in the flat interval approach of FIGS. 6 and 7 (i.e., five daily subtotals for each of 4096 days), whereas the same subtotals may be combined into just five level-twelve buckets in the hierarchical interval approach. Considering that the flat interval approach itself may represent a savings of numerous record retrievals per daily subtotal, both the flat interval embodiment and hierarchical interval embodiment enable determination of a credit exposure (or generation of another type of totaled value) with substantially fewer on-demand database record retrievals and totaling operations (and therefore in a substantially faster time) than in the online exposure determination described in reference to FIG. 2, and with full support for selectable horizon dates.

Another benefit of the hierarchical interval embodiment described in reference to FIGS. 8-11 is that the total number of records that must be retrieved is relatively deterministic; a desirable characteristic of a data processing operation carried out at point of sale of or in similar circumstances where employees, customers, clients, etc. are standing by, awaiting the result of the retrieval. Referring to FIG. 8, for example, the number of records required to encompass the remainder interval 401 is logically constrained to be no more than N−1 in a binary hierarchy, where N is the number of levels in the hierarchy (i.e., number of bucket levels). While the number of highest-level buckets required to span the approach interval is unlimited, the ability to assign or program different numbers of bucket levels (up to any theoretical maximum) enables an order management system (or other data totaling system) to be configured for a relatively small number of long-length buckets at the highest level.

Yet another benefit of the hierarchical interval embodiment described in reference to FIGS. 8-11 is that the bucket numbers for the hierarchical table records needed to span a given interval may be determined using arithmetic calculations and without having to search database records. Referring to FIG. 11, for example, the bucket numbers for the approach interval will be MainBktNo—(i x MaxBktLen), where i ranges from 1 to the number of highest-level buckets that precede the main bucket (a number that may be determined arithmetically based on a known system start date, earliest entry date or other predetermined date). The bucket numbers for the remainder interval may be determined, for example, using the arithmetic operations within the WHILE loop at lines 110 and 200, omitting the operations at lines 130-160. Once the bucket numbers for the approach and remainder intervals are determined, the corresponding records may be obtained from the hierarchical interval table in a single retrieval operation.

### Operational Context

The embodiments described above may be implemented in a programmed general-purpose or special-purpose computer system or in a network of computer systems. Alternatively, the embodiments may be implemented in a device that includes hardwired logic for carrying out the above-described operations, or any combination of programmed processors and hardwired logic.

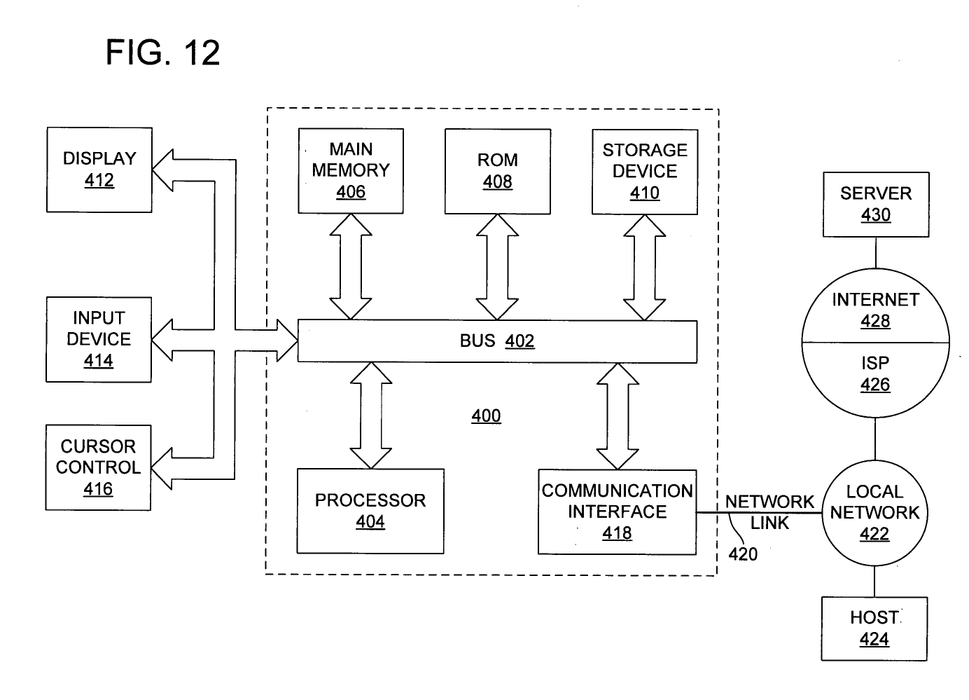

FIG. 12 is a block diagram that depicts a computer system 400 upon which an embodiment of the invention may be implemented. Computer system 400 includes a bus 402 or other communication mechanism for communicating information, and a processing entity 404 coupled with bus 402 for processing information. The processing entity 404 may include any number of general purpose and/or special purposes processors co-located within a single computing system or distributed over a network of computing systems. Computer system 400 also includes a main memory 406, such as a random access memory (RAM) or other dynamic storage device, coupled to bus 402 for storing information and instructions to be executed by processing entity 404, including the above described data structures (e.g., tables, variables, etc.) and instructions to be executed by processing entity 404 to carry out the above-described operations. Main memory 406 also may be used for storing temporary variables or other intermediate information during execution of instructions to be executed by processing entity 404. Computer system 400 further includes a read only memory (ROM) 408 or other static storage device coupled to bus 402 for storing static information and instructions for processing entity 404. A storage device 410, such as a magnetic disk or optical disk, is provided and coupled to bus 402 for storing information and instructions, such as the interval total tables described above.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processing entity 404. Another type of user input device is cursor control 416, such as a mouse, a trackball, or cursor direction keys for communicating direction information and command selections to processing entity 404 and for controlling cursor movement on display 412. This input device typically has two degrees of freedom in two axes, a first axis (e.g., x) and a second axis (e.g., y), that allows the device to specify positions in a plane.

The invention is related to the use of computer system 400 for implementing the techniques described herein. According to one embodiment of the invention, those techniques are performed by computer system 400 in response to processing entity 404 executing one or more sequences of one or more instructions contained in main memory 406. Such instructions may be read into main memory 406 from another computer-readable medium, such as storage device 410. Execution of the sequences of instructions contained in main memory 406 causes processing entity 404 to perform the process steps described herein. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processing entity 404 for execution. Such a medium may take many forms, including but not limited to, non-volatile media, volatile media, and transmission media. Non-volatile media includes, for example, optical or magnetic disks, such as storage device 410. Volatile media includes dynamic memory, such as main memory 406. Transmission media includes coaxial cables, copper wire and fiber optics, including the wires that comprise bus 402. Transmission media can also take the form of acoustic or light waves, such as those generated during radio-wave and infra-red data communications.

Common forms of computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of computer readable media may be involved in carrying one or more sequences of one or more instructions to processing entity 404 for execution. For example, the instructions may initially be carried on a magnetic disk of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processing entity 404 retrieves and executes the instructions. The instructions received by main memory 406 may optionally be stored on storage device 410 either before or after execution by processing entity 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the world wide packet data communication network now commonly referred to as the “Internet” 428. Local network 422 and Internet 428 both use electrical, electromagnetic or optical signals that carry digital data streams. The signals through the various networks and the signals on network link 420 and through communication interface 418, which carry the digital data to and from computer system 400, are exemplary forms of carrier waves transporting the information.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418.

The received code may be executed by processing entity 404 as it is received, and/or stored in storage device 410, or other non-volatile storage for later execution. In this manner, computer system 400 may obtain application code in the form of a carrier wave.

The section headings in the preceding detailed description are provided for convenience of reference only, and in no way define, limit, construe or describe the scope or extent of such sections. Also, while the invention has been described with reference to specific exemplary embodiments thereof, it will be evident that various modifications and changes may be made thereto without departing from the broader spirit and scope of the invention. The specification and drawings are, accordingly, to be regarded in an illustrative rather than restrictive sense.

What is claimed is:

1. A method of operation within a data processing system, the method comprising:
generating first totaled values that correspond to respective first intervals within a range of intervals;
generating second totaled values that correspond to respective second intervals within the range of intervals, each of the second totaled values including at least one of the first totaled values and each of the second intervals encompassing at least one of the first intervals; and
storing the first totaled values and second totaled values within the data processing system.

2. The method of claim 1 wherein the first intervals each have a first length, and the second intervals each have a second length, the second length being twice the first length.

3. The method of claim 1 wherein generating first totaled values that correspond to respective first intervals within a range of intervals comprises generating totaled values that correspond to respective time intervals within a period of time.

4. The method of claim 1 wherein generating first totaled values that correspond to respective first intervals comprises:
selecting a plurality of records from a database, each record including a first field to be included in a totaling calculation, and a second field that specifies one of the first intervals; and
totaling the first fields of the plurality of records for which the second fields specify the same first interval.

5. The method of claim 4 wherein totaling the first fields of the plurality of records comprises combining the first fields in a mathematical operation.

6. The method of claim 5 wherein combining the first fields in a mathematical operation comprises summing the first fields.

7. The method of claim 4 wherein totaling the first fields of the plurality of records comprises selecting one of the first fields according to at least one selection criterion.

8. The method of claim 7 wherein selecting the one of the first fields according to at least one selection criterion comprises selecting the one of the first fields that is superlative in regard to the at least one selection criterion.

9. The method of claim 8 wherein selecting the one of the first fields that is superlative comprises comparing the first fields against one another.

10. The method of claim 1 further comprising:
obtaining a value that indicates a first sub-range within the range of intervals;
generating a third totaled value that includes each of the first totaled values for which the corresponding first intervals are encompassed by the first sub-range.

11. The method of claim 10 wherein generating the third totaled value comprises:
generating a fourth totaled value that includes each of the second totaled values for which the corresponding second intervals are encompassed by the first sub-range;
generating a fifth totaled value that includes each of the first totaled values for which the corresponding first intervals are encompassed by the first sub-range, excluding the first totaled values that are included in the second totaled values for which the corresponding second intervals are encompassed by the first sub-range; and
totaling the fourth and fifth totaled values.

12. The method of claim 1 wherein storing the first totaled values comprises storing the first totaled values in respective records of a database.

13. The method of claim 12 wherein storing the second totaled values comprises storing the second total values in respective records of the database.

14. The method of claim 1 wherein each of the first and second totaled values is a scalar value.

15. The method of claim 1 wherein each of the first and second totaled values is a vector value.

16. A method of determining a credit balance, the method comprising:
generating first balance totals that correspond to respective first intervals of time;
generating second balance totals that correspond to respective second intervals of time, each of the second balance totals including at least one of the first balance totals and each of the second intervals of time encompassing at least one of the first intervals of time; and
summing a subset of the first and second balance totals.

17. The method of claim 16 wherein summing a subset of the first and second balance totals comprises:
generating a first sum of balance totals by summing the second balance totals for which the corresponding second time intervals precede a point in time; and
generating a second sum of balance totals by summing the first balance totals for which the corresponding first time intervals precede the point in time and are not encompassed by any of the second time intervals that precede the point in time; and
adding the first and second sums.

18. The method of claim 17 further comprising receiving user input that specifies the point in time.

19. The method of claim 16 wherein generating first balance totals that correspond to respective first intervals of time comprises:
identifying, for each of the first intervals of time, a subset of database records having a time entry that corresponds to the first interval of time; and
summing balance amounts included within the subset of database records.

20. The method of claim 19 wherein each of the first intervals of time is a respective calendar day.

21. The method of claim 19 wherein each of the first intervals of time is a respective calendar day, and wherein the time entry includes a date value.

22. The method of claim 19 wherein identifying a subset of database records comprises identifying a subset of database records having a first balance type.

23. The method of claim 16 wherein the first intervals of time each have a first length and the second intervals of time each have a second duration, the second duration being twice the first length.

24. A computer-readable medium carrying one or more sequences of instructions which, when executed by one or more processors, causes the one or more processors to:
generate first totaled values that correspond to respective first intervals within a range of intervals;
generate second totaled values that correspond to respective second intervals within the range of intervals, each of the second totaled values including at least one of the first totaled values and each of the second intervals encompassing at least one of the first intervals; and
store the first totaled values and second totaled values within the data processing system.

25. A computer-readable medium carrying one or more sequences of instructions which, when executed by one or more processors, causes the one or more processors to:
generate first balance totals that correspond to respective first intervals of time;
generate second balance totals that correspond to respective second intervals of time, each of the second balance totals including at least one of the first balance totals and each of the second intervals of time encompassing at least one of the first intervals of time; and
sum a subset of the first and second balance totals.

26. A system comprising:
a processing entity;
a memory coupled to said processing entity having data stored therein and having program code stored therein which, when executed by said processing entity, causes said processing entity to:
generate first totaled values based on the data stored in the memory, the first totaled values corresponding to respective first intervals within a range of intervals;
generate second totaled values that correspond to respective second intervals within the range of intervals, each of the second totaled values including at least one of the first totaled values and each of the second intervals encompassing at least one of the first intervals; and
store the first totaled values and second totaled values within the memory.

27. A system comprising:
a processing entity;
a memory coupled to said processing entity having data stored therein and having program code stored therein which, when executed by said processing entity, causes said processing entity to:
generate first balance totals based on the data stored in the memory, the first balance totals corresponding to respective first intervals of time;
generate second balance totals that correspond to respective second intervals of time, each of the second balance totals including at least one of the first balance totals and each of the second intervals of time encompassing at least one of the first intervals of time; and
sum a subset of the first and second balance totals.

28. A method of operation within a data processing system, the method comprising:
selecting a plurality of records from a database, each record including a first value that indicates an interval within a range of intervals, and a second value that corresponds to the interval specified by the first value;
generating a respective subtotal record for each distinct interval indicated by the second values of the plurality of records, each subtotal record including a subtotal value that is a total of the first values that correspond to the distinct interval;
obtaining a value that indicates a first sub-range within the range of intervals; and
generating a total value that includes each of the subtotal values that correspond to a distinct interval within the range of intervals.
